(19) United States
(12) Patent Application Publication
(10) Pub. No.: US 2015/0318780 A1
(43) Pub. Date: Nov. 5, 2015

(54) Bridgeless PFC Using Single Sided High Frequency Switching

(71) Applicant: Marco Antonio Davila, Tucson, AZ (US)

(72) Inventor: Marco Antonio Davila, Tucson, AZ (US)

(21) Appl. No.: 14/535,000

(22) Filed: Nov. 6, 2014

Related U.S. Application Data
(60) Provisional application No. 61/901,321, filed on Nov. 7, 2013.

(51) Int. Cl. H02M 1/42

(52) U.S. Cl. CPC H02M 1/42

(57) ABSTRACT

A new converter topology and control methods are presented that can be used for bridge less power factor conversion that are simple and do not introduce large common mode noise.

### RELATED APPLICATION/CLAIM OF PRIORITY

This application is related to and claims priority from U.S. provisional application Ser. No. 61/901321, filed Nov. 7, 2013, which provisional application is incorporated by reference herein.

### INTRODUCTION

The art of engineering has always been of using the available tools and devices most efficiently. As new electronic devices become available power supply topologies and control methods are discovered or changed to favor the new devices. This application introduces two methods, one for the available traditional silicon switches (trench MOSFET and supper junction MOSFET) and another for the new gallium nitride (GaN) devices.

In traditional power factor converters (PFCs) the reverse recovery of the rectifier has been addressed by either a lossless snubber or by silicon carbide diodes. Silicon carbide Schottky diode was a new device that also changed the topology back to an ideal boost converter instead of having to the use a lossless snubber for rectification. In the same way, the GaN devices have a particular behavior with reverse current that can be exploited to yield very fast switching. While most think that not having a body diode is a detriment it is not. The continuous mode in this application utilizes this “feature” of the GaN devices. This ability allows the GaN device during a full AC period to function as both the rectification device and the main device. This removes the need for silicon carbide diodes and also simplifies the topology eliminating half the input bridge.

While GaN has these advantages they are not fully developed as of this time so this application also addresses devices that have slow body diodes with a new control method and operating condition.

### PRIOR ART

Traditional power factor converters (PFCs) have a similar design as presented in FIG. 1. They have a low frequency diode bridge followed by a boost converter. Reverse recovery of the main rectifier (8) was a major source of power loss. One improvement to address this problem was to add a lossless snubber to recover some of the energy lost during reverse recovery as shown in FIG. 2. Other techniques were used for this problem. With the use of silicon carbide diodes most topologies reverted back to the schematic of FIG. 1.

The next problem to address was the extra drop of the diode bridge. Since the boost converter itself is part of a bridge network it can incorporate part of the diode bridge thus getting rectification and boosting at the same time. But which part of bridge that is replaced is an option. FIGS. 3, 4, and 5 all show “bridge less PFCs”; silicon carbide diodes are shown with Schottky diode symbols. The term “bridge less” is a misnomer; these topologies are actually replacing portions of the bridge not all the bridge. Some topologies are simple but introduce common mode noise if the primary common has high frequency switching between it and input phases. For example, the topology of FIG. 3 has a single choke (3) but 2 switches (3) (5) on the bottom side. The two top rectifiers are silicon carbide diodes (2) (4) thus solving the reverse recovery problem, but since the other switch (5) on neutral switches when phase is negative, it references neutral to common then alternatively to Vout. Adding a choke to both sides does not correct the common mode noise problem unless it is done as in FIG. 5. But this adds an extra choke to correct the problem (the chokes cannot be coupled). What is needed in the art is a power factor correction topology that is bridgeless, simple, and does not introduce common mode noise.

### SUMMARY OF THE PRESENT INVENTION

The present invention provides a new and useful power factor conversion method, that meets the foregoing objectives

In one of its aspects, the present invention provides a method of electronic power conversion with an inductor followed by a higher than line frequency switching half bridge combined with a diode half bridge to rectify and boost the input AC line. With this method, active bridges can replace the diode portion of the half bridge switched at the line frequency.

In another aspect of the present invention, an electronic power control method employs rectifying circuitry (e.g. half bridge rectifying circuitry) and dual current thresholds to control both portions of the switching cycle for the rectifying circuitry. In this aspect of the present invention, thresholds of opposite polarity can be used. Also, particular thresholds are calculated so that both transitions will have soft commutation for the targeted average current.

In yet another aspect of the present invention an electronic power control method employs rectifying circuitry (e.g. half bridge rectifying circuitry) and a single current threshold that can be moved to either control the lower ramp threshold or upper ramp threshold for the rectifying circuitry. In this aspect of the present invention the smaller of a positive ramp or negative ramp portion is used.

In still another aspect of the present invention, an electronic power control method employs rectifying circuitry (e.g. half bridge rectifying circuitry) and a single current threshold and calculating the total period required to achieve the other current threshold for the rectifying circuitry.

In yet another aspect of the present invention, an electronic power control method employs rectifying circuitry (e.g. half bridge rectifying circuitry) and a single current threshold for the ramp up and calculating the ramp down time required and setting the ramp down time for the rectifying circuitry.

In still another aspect of the present invention, an electronic power control method employs rectifying circuitry (e.g. half bridge rectifying circuitry) and a single current threshold for the ramp down and calculating the ramp up time required and the setting the ramp up time of the rectifying circuitry.

These and other features of the present invention will become apparent from the following detailed description and the accompanying drawings

### BRIEF DESCRIPTION OF THE DRAWINGS

FIG. 1 shows circuitry for a traditional power factor converter (PFC);

FIG. 2 shows addition of a lossless snubber to recover some of the energy lost during reverse recovery;

FIGS. 3, 4, and 5 all show “bridge less PFCs”, with silicon carbide diodes shown with Schottky diode symbols;

FIG. 6 shows a circuit for a Single Sided High Frequency Bridgeless PFC, according to the present invention;

FIGS. 7 and 8 show voltage and current wave form schematics for the circuit of

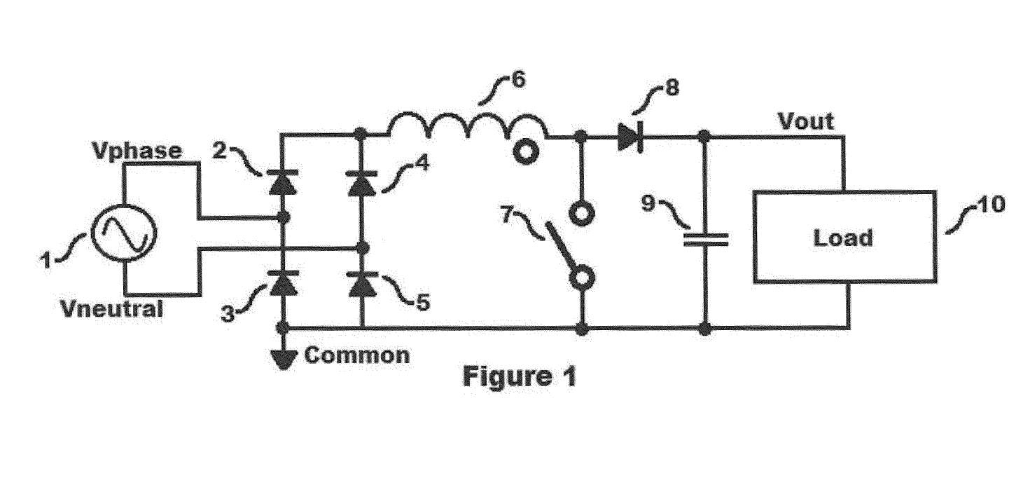

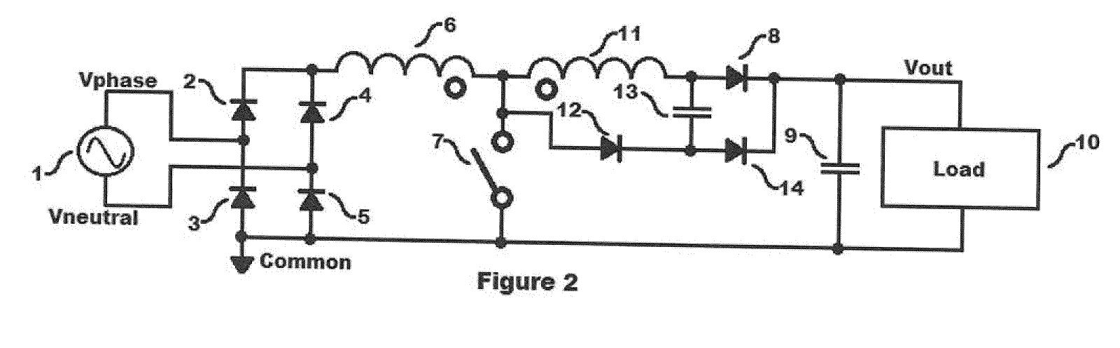

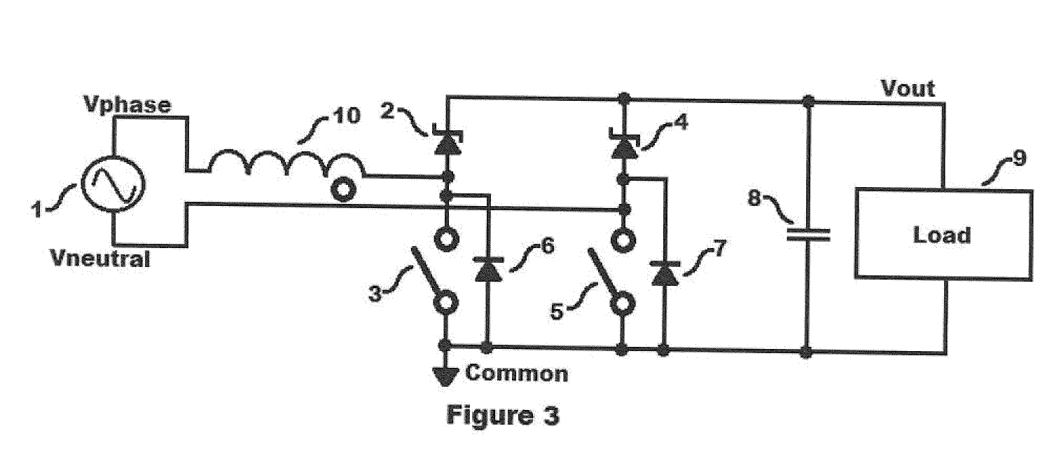

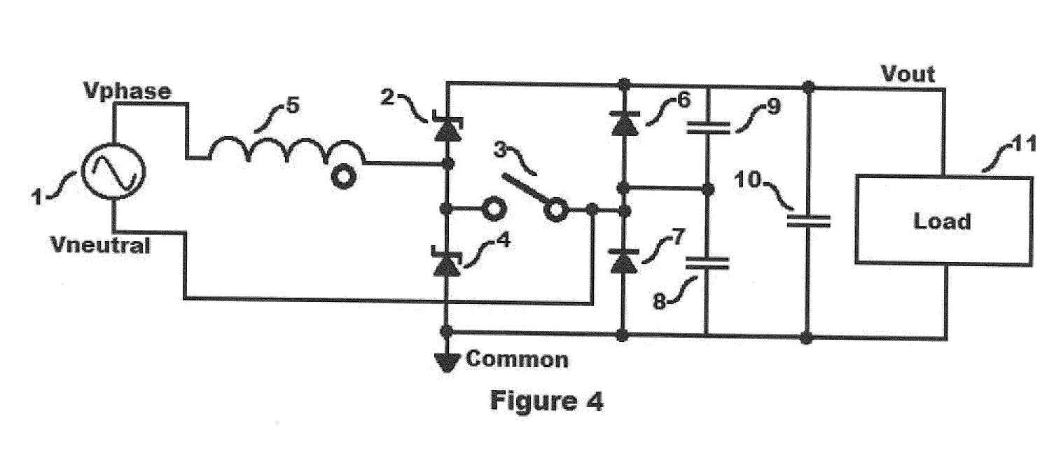

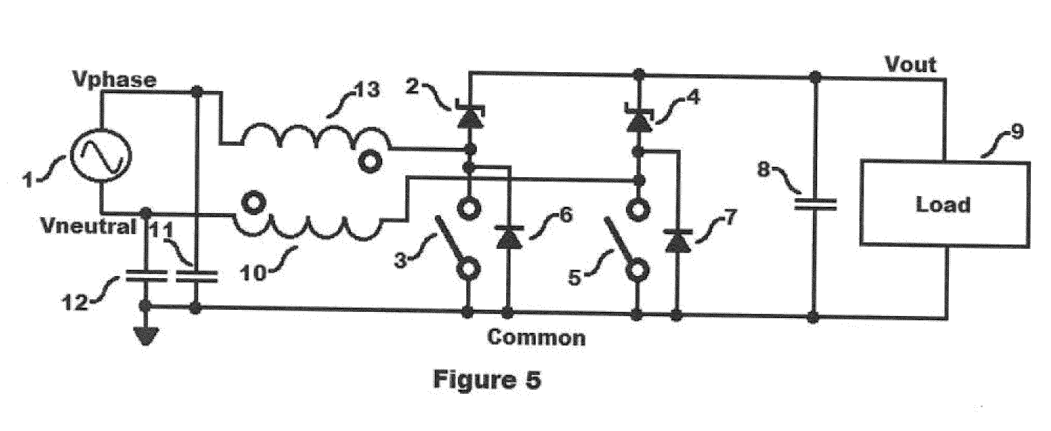

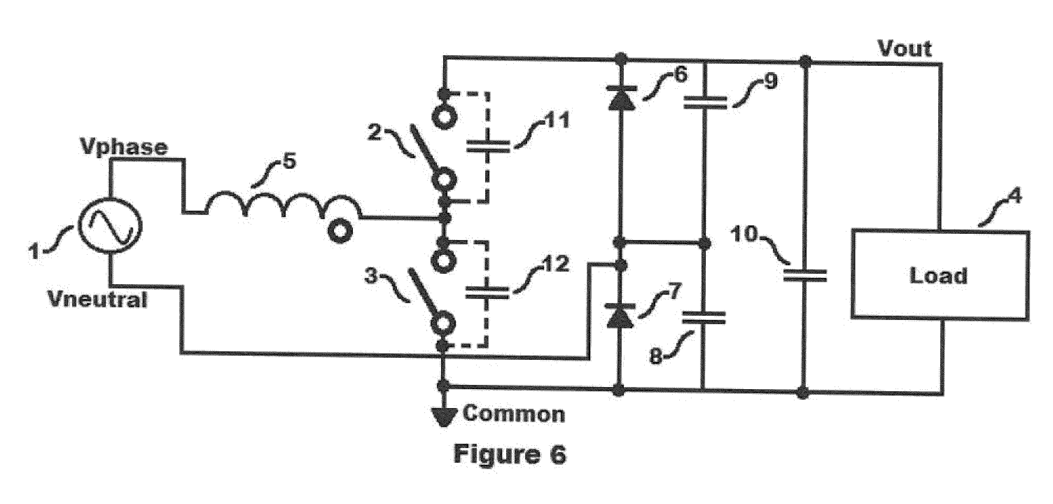

FIG. 6;

FIG. 9 shows the frequency versus input voltage at 450 W out and 230 Vac in with a 200 uH input choke, in a circuit according to the present invention;

FIG. 10 shows a circuit according to the present invention, where in order to increase the efficiency further, an active bridge is controlled, by replacing the diodes in FIG. 6 with switches;

FIG. 11 shows an alternating current threshold method, according to the present invention, where a determination is made as to whether the on time or off time is smaller and the threshold is applied to the smallest time, so that the requirement for slope compensation is removed since the fastest ramp is always used for control; FIG. 11 also shows a control method in which only one threshold is used (upper or lower) but the other threshold is calculated internally and a calculated off time is used;

FIG. 12 shows a circuit, with a dual current control method according to the invention, where the inductor current is be measured continuously, using 2 current transformers (13, 14) to synthesize the choke current waveform.

FIG. 13 shows current control for the case of a bridgeless PFC converter (e.g.

the converter of FIG. 6) operating in boundary or transition mode, according to the principles of the present invention;

FIGS. 14 and 15 show how to provide a minimum time ripple calculation, in a control method according to the present invention, to prevent increasing the switching frequency;

FIGS. 16 and 17 show equations for controlling Ipb, according to the present invention;

FIG. 18 shows how the current control method could be expanded from a boundary mode operation to a continuous mode power factor corrected converter, in accordance with the present invention;

FIGS. 19 and 20 show equations for preventing a lower frequency during continuous conduction mode for both polarities of line;

FIG. 21 shows combined and simplified equations for all modes are shown; and

FIG. 22 shows a half bridge circuit with parasitic elements included, to show switching transitions, in accordance with the present invention.

### DETAILED DESCRIPTION

As described above the present invention provides a new and useful power factor conversion method and topology that is bridgeless, simple, and does not introduce common mode noise. The following detailed description provides several topologies and methodologies that accomplish those goals.

3. Single Sided High Frequency Critical Mode Bridgeless PFC (According to the Present Invention)

Shown in FIG. 6 is a circuit for a Single Sided High Frequency Bridgeless PFC, according to the present invention. It is the same circuit for both critical mode and continuous mode. The difference is in the design of the choke and how the circuit is controlled. Switch (2) and switch (3) are considered to be MOSFETS with some degree of parasitic output capacitances (11) and (12). The output voltage Vout to common is larger than any expected voltage on the input; the unit functions as a boost converter.

When phase is positive compared to neutral switch (3) will act as the main switch and switch (2) will act as a synchronous rectifier. The average current flowing in inductor (5) is positive (towards the switches) therefore Diode (7) is forward bias and capacitors (8) (9) are large enough to maintain an average voltage equal to its diode drop (Vd) which is small compared to the input voltage. The voltage across capacitor (9) is equal to Vout+Vd. Current will be considered positive in the inductor (5) flowing towards the switches (2) and (3).

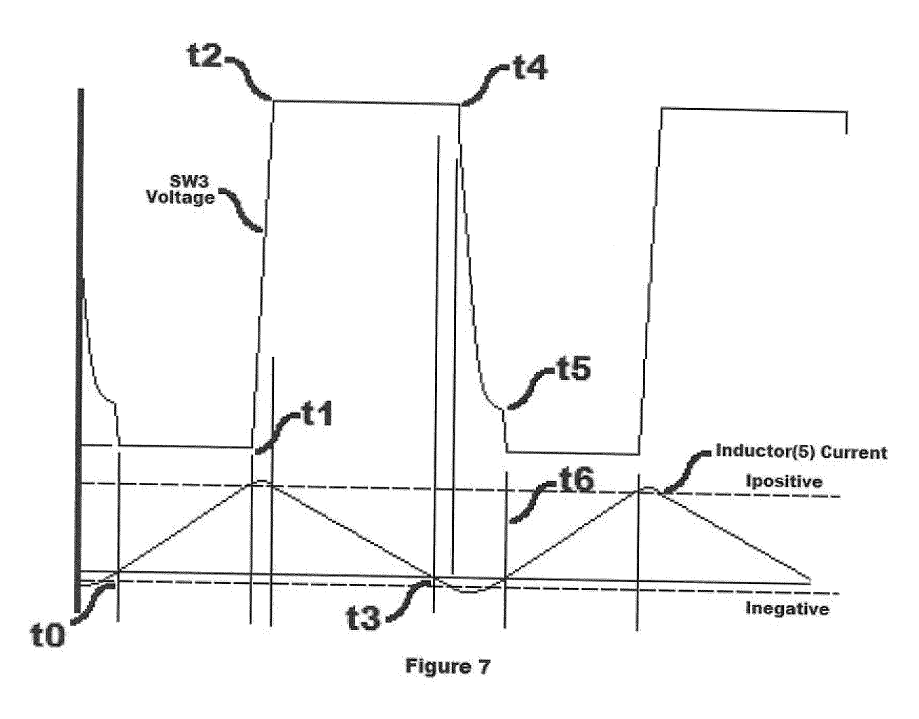

For positive phase operation see FIGS. 6 and 7. During t0, switch (3) is on and the current starts from zero and ramps up. Current is increasing linearly based on the phase voltage relative to common which at this positive phase is referenced to neutral through diode (7). Diode (7) will be assumed to be forward biased. Cases for other situations will be discussed later in this application. The current then increases proportionately to the difference between phase and common following the inductor equation di/dt=Vphase/L1=(Vphase−Vneutral−Vd2)/L1. At a positive current threshold determined by the controller, switch (3) is turned off at t1. Since the current in the inductor must continue to flow it fills up the parasitic capacitance of switch (3) and discharges the parasitic capacitance of switch (2). When the voltage difference of the across switch (2) reaches zero switch (2) is turned on at t2 (Zero Voltage Switching).

The current in inductor (5) continues to flow up through switch (2) delivering current to Vout. The current decays since the voltage on the output is positive compared to phase. The current decays at a rate proportional to Vout−Vphase following the equation di/dt=(Vphase−Vout)/L1=(Vphase−Vneutral−Vd2−Vout)/L1. The current re-crosses zero going the other way at time t3. Switch (2) continues to be on past this point thus the current becomes negative. At a negative current threshold that is determined by the controller switch (2) is turned off at time t4. This negative current then charges the parasitic capacitance of switch (2) and discharges the parasitic capacitance of switch (3). When either the energy of the negative current reaches zero during the transition (t6) or the voltage across switch (3) reaches zero, switch (3) is turned on (t5). This starts a new period at time t6. Shown in the FIG. 7 is the case when the energy in the current reaches zero, so the voltage did not reach zero before the switch is turned on and both times t5 when the switch turns on and time t6 when current is at zero happens at the same time.

The value of negative current threshold is a compromise. If it is too large zero voltage switching is guaranteed for switch (3) but this reduces the average forward current which must be compensated for by increasing the positive current threshold. This in turn increases the total RMS current in the inductor. In order to increase efficiency, the controller choses the correct amount of negative current for particular situation to have zero or near zero volt switching but no more.

This “negative” current or reverse power current is referred in this document as push back current and also occurs in the opposite polarity. This push back current will be referred in this paper as an absolute quantity.

Since the current has ripple and reverses polarity, capacitors (8) and (9) are needed to hold the voltage steady. The average current is positive and diode (7) is forward biased in this mode.

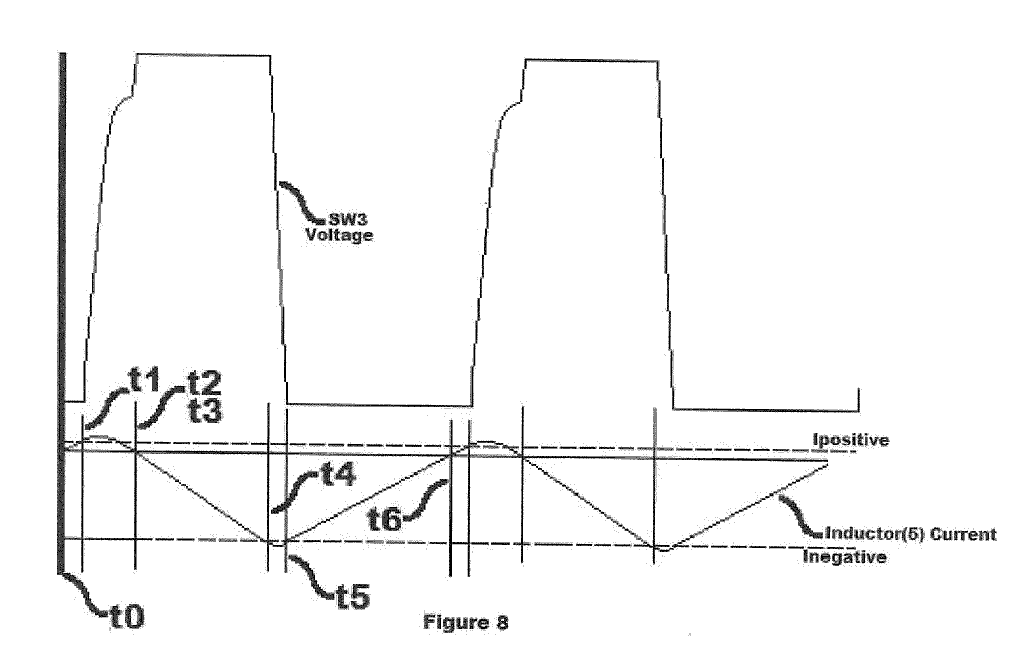

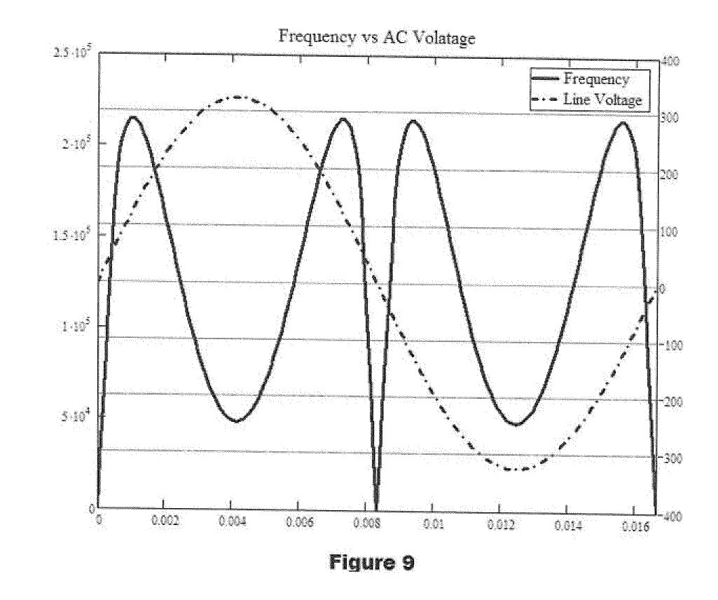

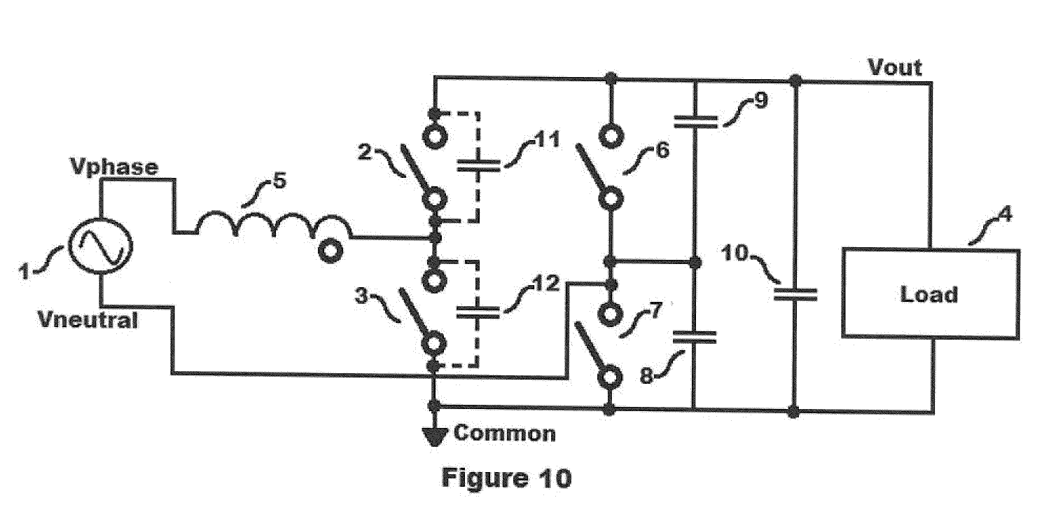

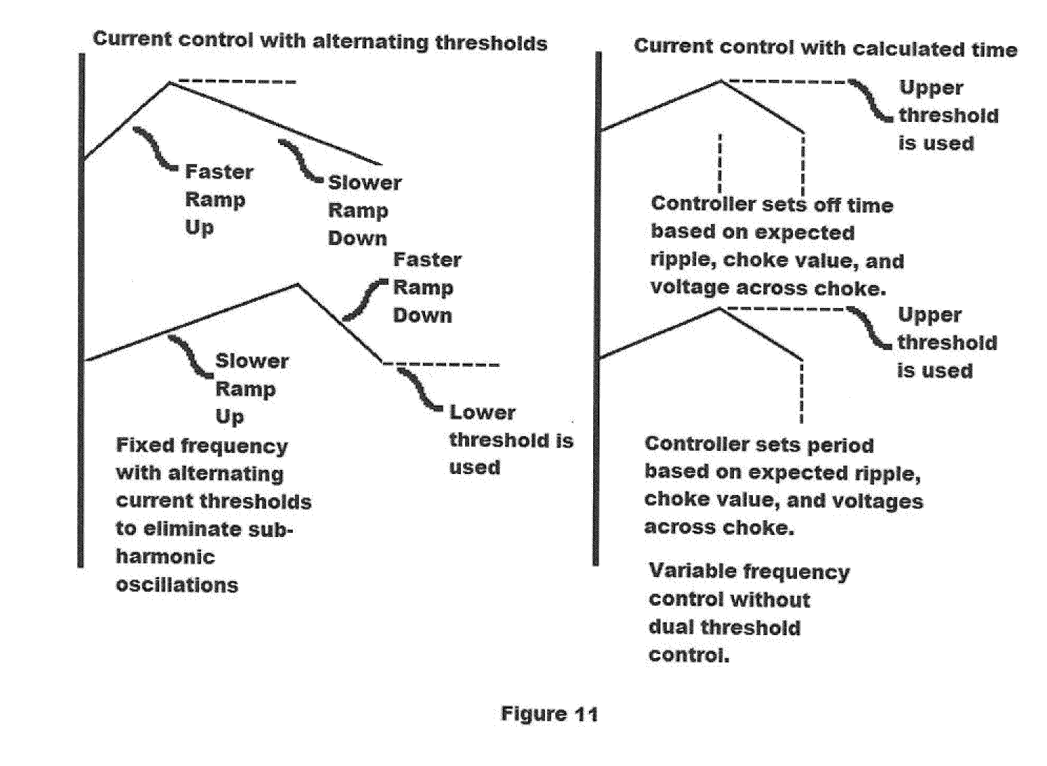

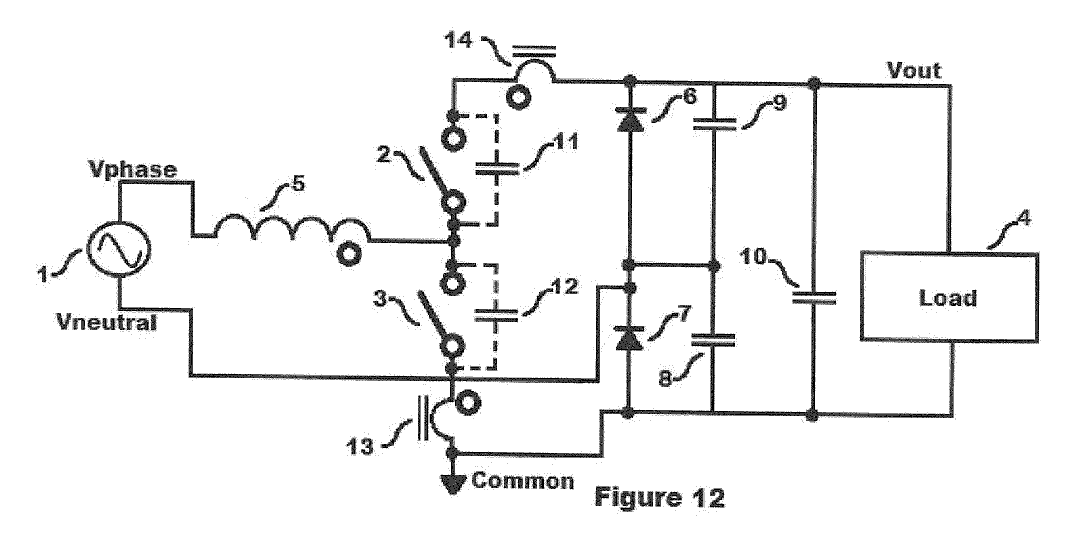

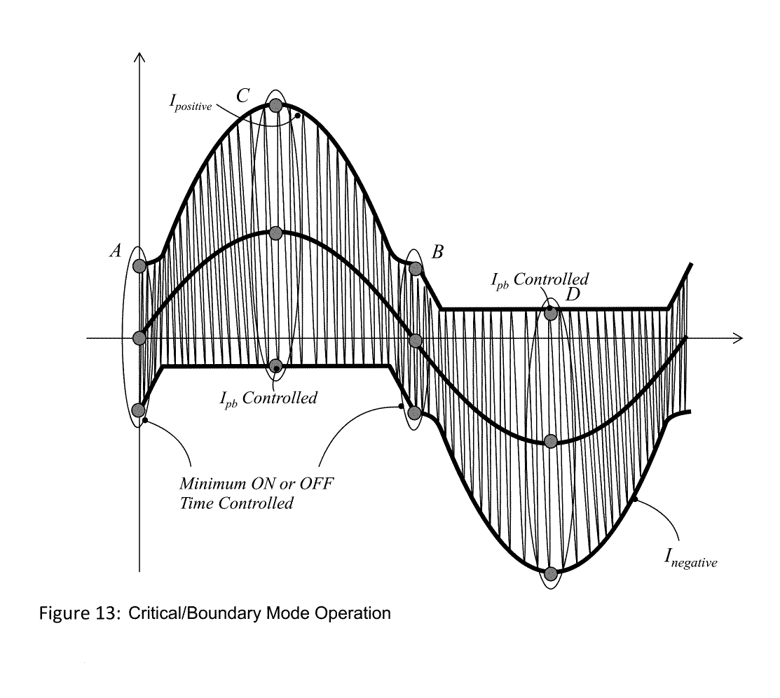

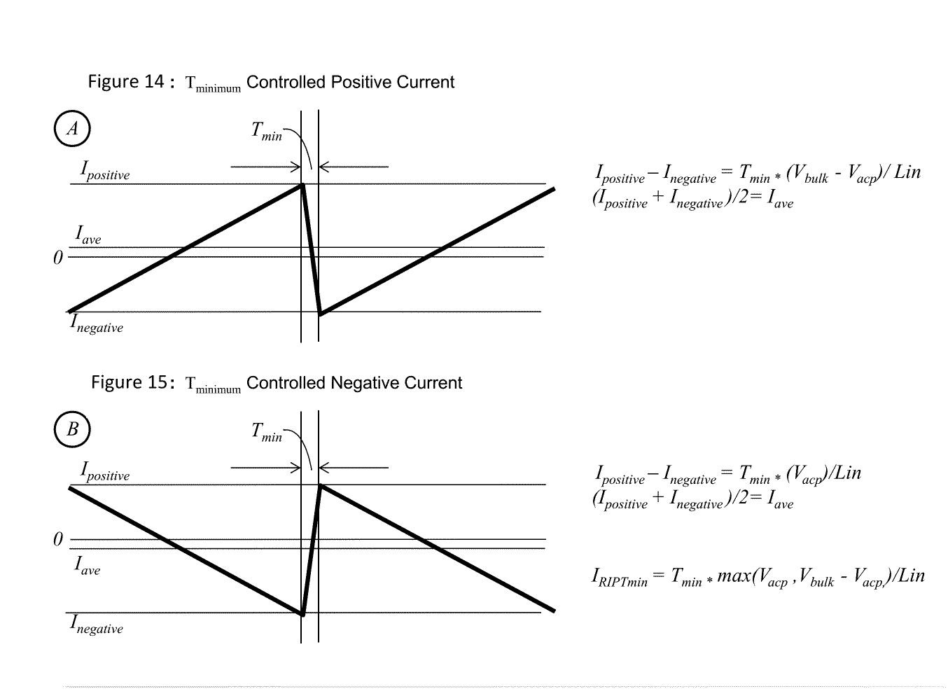

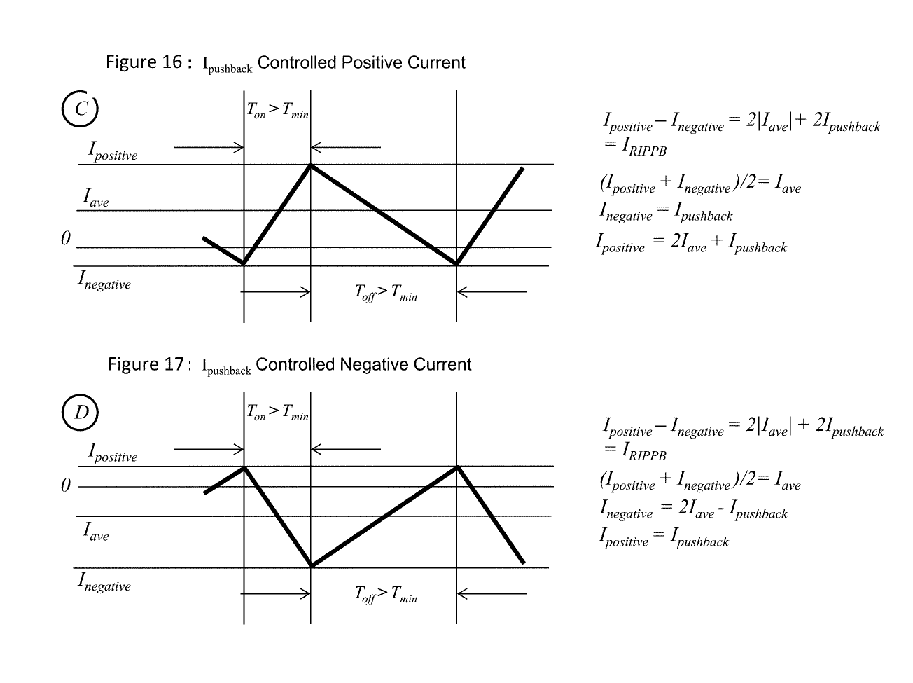

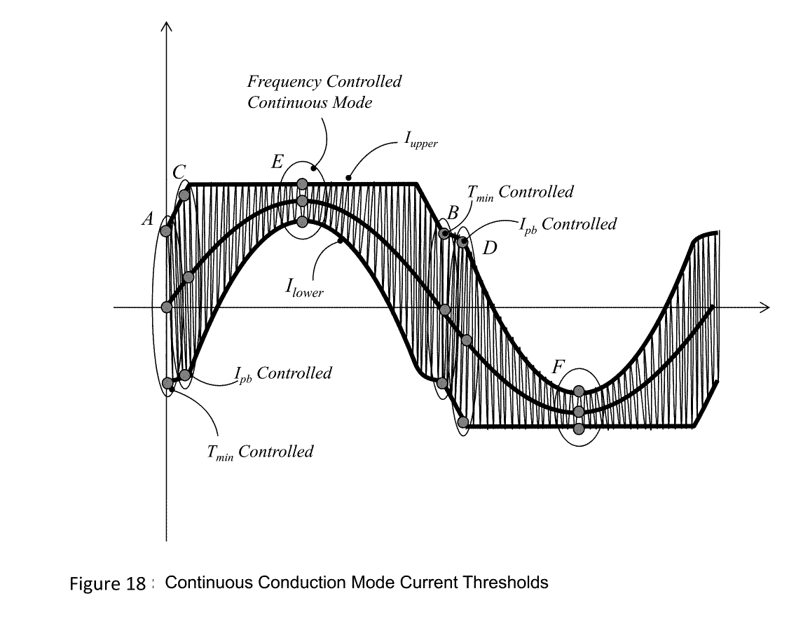

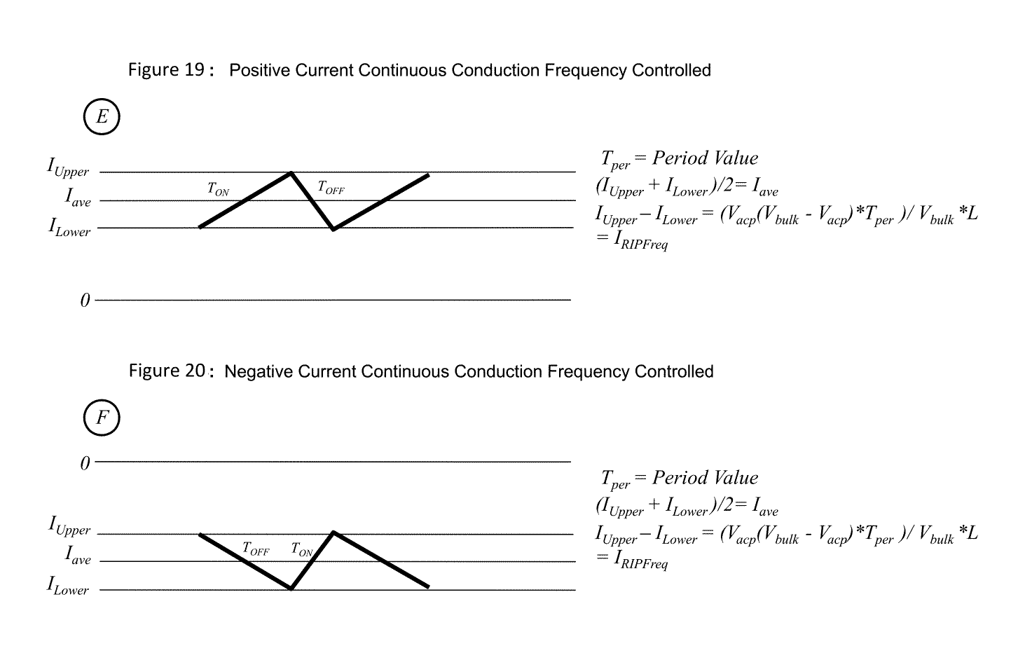

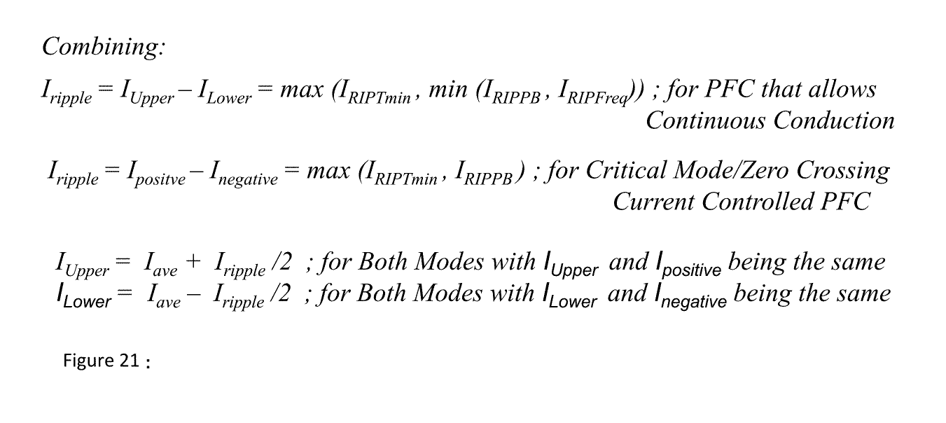

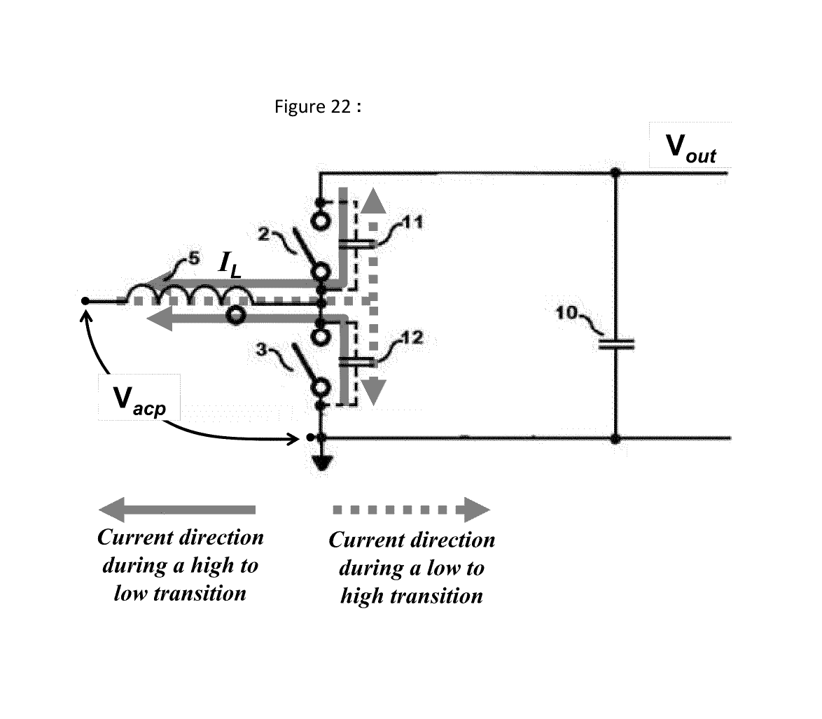

When phase is more negative than neutral the roles of switches (2) and (3) are reversed in terms of which is the boost switch and which is the synchronous rectifier, see FIGS. 6 and 8. The average current in this mode is negative (flowing towards phase). In this situation diode (6) is forward biased and diode (7) is reversed biased. Neutral is a diode drop away in voltage to Vout. The voltage across capacitor (8) is charged to Vout+Vd2. Capacitor (9) has a diode voltage drop across it. Switch (3) is on at t0 and the current is ramping up as before. The current ramps proportional to Vphase following the equation di/dt=Vphase/L1=(Vphase−Vneutral+Vd+Vout)/L1. At a small positive current threshold switch (3) is turned off at t1. This positive current then charges the parasitic capacitance of switch (3) and discharges the parasitic capacitance of switch (2). When either the current reaches zero (time t3) during the transition or the voltage across switch (2) reaches zero (time t2), switch (2) is turned on at t2. Time t3 when current reaches zero and time t2 when the switch turns on happens at the same time in FIG. 8. It is also possible that the voltage across the switch reaches zero before the current reaches zero. In this case the switch is turned on when the voltage reaches zero at t2, then the current reaches zero after at t3. This depends on the quantity of positive current programmed.

Again the value of the positive current is a compromise. If too large zero voltage switching is guaranteed for switch (2) but this reduces the average negative current which must be compensated for by increasing the negative current threshold. This in turn increases the total RMS current in the choke. This is similar to the positive phase case. This absolute value of current (the push back current) is the same in both situations with voltages and currents reversed.

The current in the input choke ramps down proportional to Vphase−Vout and follows the inductor equation of di/dt=(Vphase−Vout)/L1=(Vphase−Vneutral+Vd)/L1. At time t4 the current hits the negative threshold set by the controller and switch (2) is turned off. With this large negative current the parasitic capacitance of switch (2) is charged and the capacitance of switch (3) is discharged quickly. When the voltage across switch (3) is zero then switch (3) is turned on at t5. The current then ramps up as before following the same equation as between times t0 and t1 crossing zero at time t6 which starts a new period.

There are times close to polarity reversal of the phase and neutral that the currents become very small. When polarity reversal occurs, the previous voltage position of neutral compared to common is conserved due to the capacitance of (9) and (10). The controller still maintains a positive current threshold and negative current threshold. Since the voltage on phase or neutral is clamped by the bridge and body diodes of the switches (if implemented with MOSFETS), phase and neutral must be between Vout and ground. After phase reversal the average current charges the node of capacitor (8) and capacitor (9) to the other neutral setting. The transition is gradual and produces very little common mode noise and only at the input line frequency. Because the controller is current mode, it is not disturbed by the voltage swing on the neutral line and maintains the correct average, positive, and negative current settings.

The controller monitors phase and neutral voltages in relation to common to determine current direction and to compute the positive and current thresholds. The thresholds are adjusted so that power factor is maximized by measuring the average current and comparing its shape to the difference between phase voltage and neutral voltage.

In order to minimize root mean square (RMS) currents, the smallest positive and negative threshold are used. This also causes the converter to run with variable frequency. Shown in FIG. 9 is the frequency versus input voltage at 450 W out and 230 Vac in with a 200 uH input choke. The peak of input voltage is also the peak of input current in order to have good power factor. The on time is somewhat fixed at all input conditions for a particular output load, but at the peak, the off time is extended since the differences between phase and Vout is small. Therefore at the peak of the line and the peak of the power the frequency is the lowest. This produces very efficient operation at peak power which is the most important point in terms of average power over the whole cycle. During times that the line is low the controller limits the smallest off time. In this case the on time must increase to compensate for this. This produces very low frequency at low amplitudes of input voltages (phase vs. neutral). This is also a favorable situation since it reduces the light load overhead by reducing the frequency of operation thus reducing the driving losses. The maximum frequency point occurs close to when the input voltage is half of the output voltage. At heavier loads this frequency is low but can be high at lighter loads. The maximum frequency is limited by the needed zero volt switching (ZVS) condition of the push back current. Even under no load condition the minimum that the positive or negative threshold can be is the +/−Ipushback level. The maximum frequency can then be determined from the inductor value and the Ipushback programmed at this middle point using the following equation Freqmax=Vout/(8*Ipushback*Lin), where Lin is the inductance of the input inductor (5). Super junction MOSFETs alter this equation since they have non-linear capacitance characteristics that alter the transition times which are not included in the equation. But to the first order the equation is accurate.

The shape of the current in the input choke is triangular and in order to have low switching losses, crosses through zero twice during one switching period. For this shape, the average current is ½(Ipositive+Inegative). Where the Ipositive is the positive current threshold and Inegative is the negative current threshold. If an average positive current is desired, Ipositive must be increased while minimizing Inegative. If a negative current is desired Inegative must be increased while minimizing Ipositive. At zero load, Inegative and Ipositive can be the same amplitude thus producing an average of zero. Calculating the thresholds from the average and push back current desired gives the following two equations Ipositive=Iave+|Iave|+Ipushback and Inegative=Iave−|Iave|−Ipushback. The ripple component is Ipositive−Inegative=2*|Iave|+2*Ipushback. Note that lave can be a positive or negative quatity and Ipushback is always a positive quantity in the equation.

The controller follows some rules to assure optimum efficiency and safe operation. First rule is that one current threshold must be a minimum positive value of Ipushback and the other one a maximum negative value of −Ipushback. Second rule is that there is a minimum on time for either of the switches (2) and (3). This rule is most often taken care of by following the first rule but there are exceptions. This rule assures limited pulse sizes and helps produce lower frequencies during light load situations. During low input line conditions the “off portion” or reset can be very short. During these conditions corrected threshold levels are imposed that will not violate the minimum ramp up or ramp down time. This is calculated by the controller by taking the maximum of the following two voltages: Vphase and (Vout−Vphase) then multiplying by the following factor Tmin/Lin. This current ripple (peak to peak) is compared to the ripple that appears normally (2*Ipushback+2*|Iave|) and the maximum of the two is used. The previous equation for Ipositive and Inegative is modified to the following two equations: Ipositive=Iave+Iripmax/2, Inegative=Iave−Iripmax/2. Where Iripmax is maximum ripple calculated. Note that Iripple is a positive quantity in both equations.

Current mode control normally needs slope compensation to prevent sub-harmonic oscillations. This occurs when the ramp up slope is larger than the ramp down slope and the slower ramp is the controlling threshold. The sensitivity to the down slope amplifies the oscillations since a small change in slow ramp time creates a large effect in ramp down. By controlling also the ramp down level this control method is immune to sub-harmonic oscillations. Actually this does not occur because of two facts, first both the ramp up and ramp down is controlled so there is always a faster ramp that is controlled, second the frequency is not fixed so there is always time to reach both controlled levels. Current mode control has been used in the past with a single threshold but by using two thresholds (dual threshold current mode control) this controller solves the slope compensation problem. In the continuous mode PFC section further techniques of preventing sub-harmonic oscillations will be presented.

In order to increase the efficiency further, the controller can also control an active bridge for rectification; see FIG. 10, by replacing the diodes in FIG. 6 with switches. Since the controller already knows the polarity of the input line (Vphase−Vneutral), it can turn on the correct switch (6) or (7). In addition, it knows if the neutral line reached one of the rails (either Vout or common). If it waits for the transition to occur naturally, it can turn on either switch in ZVS conditions. This prevents large dv/dt on the neutral line during turn on that would produce increased common mode noise.

4. Single Sided High Frequency Continuous Mode Bridgeless PFC

Using the same schematic as the critical mode PFC and using switches that can act as fast diodes the topology can run in continuous mode. This implies that the current thresholds do not have to be of opposite polarity. This eliminates the advantage of zero or near zero voltage switching but reduces the RMS current in the choke by employing a trapezoidal current shape. This shape has more DC component per RMS compared to the triangular shape. The new GaN switches promise to be just what is needed to run the converter in continuous mode operation. Enhancement mode GaN switches do not have an intrinsic body diode and turn on with reverse bias if the gate is at the same voltage as the source. In this condition the switch is in a linear region and has the drop equal to the gate threshold if the switch is an enhancement mode type. The time that the gate is not enhanced must be minimized in order to reduce the dissipation during this period. Choosing the dead time between switches becomes important.

If the GaN switch is a depletion mode device and implemented with a cascode arrangement with a lower voltage enhancement mode switch the drop is equal to the body diode of the cascoded small MOSFET. In this arrangement the reverse recovery of the lower voltage switch affects the reverse recovery of overall switch. Again timing is critical to reduce the amount of reverse current conducted by the cascoded MOSFET. If the reverse current is minimized the reverse recovery effects are also minimize due to the majority of the current will flow in the parasitic capacitance of the small MOSFET instead of the body diode reducing the reverse recovery charge.

If depletion mode GaNs are used without a cascoded switch, the circuitry around the device must drive the device with a negative voltage to turn off the device. In order to prevent a short at start up, regular non-switching silicon cascoded MOSFETs can be used. The silicon MOSFETS are turned on after proper gate drive is available for the depletion mode GAN devices. The MOSFET switches remain on after the unit powers up and do not have high frequency switching.

Controlling the continuous mode power factor converter can be with the dual current threshold described above with no differences except for the removal of the requirement that current must cross zero. The new rule would be only that one threshold is above the other. Controlling this way will produce variable frequency operation and efficiency trade off can be decided between ripple amplitude and frequency of operation. Again slope compensation is not needed for dual threshold current mode control.

Another control method is using a single threshold and fixed frequency operation. The problem with this is that slope compensation may be needed. Instead, a single threshold is used but the controller decides if the lower or upper threshold should be used so that slope compensation can be avoided. In this alternating current threshold method, the controller determines whether the on time or off time is smaller and applies the threshold to the smallest time, see FIG. 11. In this way, the requirement for slope compensation is removed since the fastest ramp is always used for control.

A third control method is that only one threshold is used (upper or lower) but the other threshold is calculated internally and a calculated off time is used, see FIG. 11. This also involves variable frequency operation but can eliminate circuitry to measure the other current in the opposite polarity. A single current sensor can be used on one of the switches and not the other. This method could also be used with a somewhat fixed frequency. If the expected lower threshold is calculated from the remaining desired period and an off time is calculated from this the unit will not experience sub-harmonic oscillations since the frequency is allowed to change slightly for the expected off time insuring that the correct end threshold is reached.

In order to use the dual current control method, the inductor current must be measured continuously. This can be done as shown in FIG. 12 with 2 current transformers (13, 14) to synthesize the choke current waveform. The sum of the two current transformers is the choke current. Two current transformers are needed in order for one to reset while the other measures the current, otherwise, a very large current transformer must be used to be able to withstand the low frequency component. Other alternative current measurements can be done with Hall Effect devices or a shunt resistor.

The dual current control method can be applied to other topologies that control an inductive element. Buck, boost, and buck-boost are example of these topologies. The sensing of the current must include both on and reset phases for the dual current threshold method. This requires 2 current transformers, resistive shunts, or Hall effect devices. Once the choke current is monitored it can be controlled with the dual threshold method. If a single current transformer is used then the single threshold with calculated off time or period method can be used. With any of current sensing methods described above slope compensation is not needed.

5. Further Control Descriptions for Bridgeless PFC Converters

Current control for the case of a bridgeless PFC converter operating in boundary or transition mode is show in FIG. 13. To be more exact, the mode shown is not boundary where the lower current threshold would be zero, in this case the current reverses beyond the boundary mode threshold. This paper still refers to this operation as boundary mode for simplicity.

In this case the switches in FIG. 6 can be replaced back with MOSFETs, as described above and also in provisional patent application 61/901321, filed Nov. 7, 2013 (and incorporated by reference) which describes details about this topology. This control method allows the use of normal MOSFETs for both roles since the current is not flowing in the body diode of each switch at the moment of turn off. The bottom switch ramps up the current and the top switch ramps down the current. During the time phase is positive compared to neutral, shown during section (C), the positive current threshold is larger than the negative current threshold. The bottom switch turns off at the peak of positive current and has a very fast ZVS transition to the top switch. The top switch stays on until the current reverses and becomes slightly negative. The amount of negative current is dependent on the amount needed for desired ZVS or near ZVS condition. The roles of the MOSFETs reverse during the time that the AC line is negative during section D.

The currents in the MOSFETS are controlled using a dual current control. Both the top and bottom currents control when the switches turns off. When the current in the choke hits the upper current threshold the bottom MOSFET is turned off and after a delay for the transition to happen the top switch is turned on. When the bottom current threshold is reached the controller turns off the top MOSFET and after a delay for the transition to happen the bottom switch is turned on. This type of control is dual current mode control and has some advantages. No slope compensation is needed. Current is controlled at turn off of each MOSFET so reverse recovery can be guaranteed to not occur. It is immune to large voltage changes on the neutral side of the converter so a large voltage swing during zero crossing of the input line still keeps the current in control.

In boundary mode operation the current ripple is at least twice the average current. Shown in FIG. 13 are the current waveforms for a PFC working in boundary mode operation. The amount of ripple current during the pushback controlled area is equal to twice the sum of the absolute value of the average current and the push back current. In order to minimize the root mean square (RMS) currents in the circuit elements, the minimum pushback current needed should be used. The amount needed is dependent on the amount of voltage swing needed and the input voltage condition at the time of turn off (see FIG. 22). FIG. 22 shows the initial conditions and the parasitic capacitances (11) and (12) of the half bridge portion of the circuit formed by the two switches (2) and (3) (MOSFETs or GaNs can be used). This involves an energy balance equation before and after the transition happens, the amount of initial current in the choke at the moment of turn off influences the transition characteristic. When the high to low transition occurs (top switch turning off) current in in the choke is towards Vacp (phase), the amount of energy in the parasitic capacitors of the switches are with one fully charged to Vout (12) and the other (11) is at zero. Let's say the energy of a parasitic capacitor fully charged to Vout is Ecp and that the energy in the choke (5) follows the classic equation Echk=½·L·Ipb². This is the starting energy. At the end of the transition the current in the choke should be zero and the opposite parasitic capacitor (11) should be charged to the full Vout level so the energy is again Ecp. What is left is the energy delivered or received by the voltage sources Vacp and Vout. Vout delivered the charge of the two series capacitors from holding capacitor (10) which is equal to the charge of one capacitor Qcp. Therefore, Vout delivered energy Evout=Qcp·Vout. The input voltage received twice the charge amount from each of the capacitors. So, the input voltage received Evacp=2·Qcp·VacP. Putting all the energy together we get Echk=½·L·Ip²=Qcp·(2·Vacp−Vout). This means

$$Ip = \sqrt{2 \cdot \frac{Qcp}{L} \cdot ( 2 \cdot Vacp - Vout )} .$$

If this equation is followed there are times that the energy needed is negative, but keep in mind that the current in the choke cannot be in the opposite direction to prevent reverse recovery on the body diode of the mosfet. For the transition in the opposite direction the signs on Vacp and Vout can be reversed. During those times that the energy needed is negative setting Ipb (push back current threshold) to zero is acceptable. The controller would then only have to measure the input voltage and output voltage to determine the amount push back current needed. A table could be used to produce this function with the input voltage measured (Vacp) as an index since Vout, Qcp, and L (choke inductance) are constants. FIG. 13 shows a constant Ipb level in areas (A) and (D) but in reality the optimum Ipb level would change according to the equation above based on input voltage.

During zero crossing the amount of ripple current is reduced since the average current needed to produce unity power factor reduces with input voltage. This will produce very fast off times. These fast off time may stress the switching devices by increasing the switching frequency. To prevent this, a minimum time ripple calculation is made. The equation for the minimum ripple is shown in FIGS. 14 and 15. Tmin is the desired minimum time setting for the converter. This implies that the ripple current would be increased beyond the push back current that is needed so that this minimum time is maintained. The purpose of this is to control the switching frequency and narrow off or on times when the input line voltage is low. This control portion of the graph is shown in FIG. 13 during (A) or (B). The average current is still maintained to follow the input line. The equations for zones (C) and (D) where Ipb is controlled are shown in FIG. 16 and FIG. 17. For the whole switching cycle both the Ipb needed and the Tmin ripple currents are calculated at every point and whichever is larger is used. This creates a smooth transition between Tmin controlled current to Ipb controlled current and is load and line dependent.

If an ideal switch converter is used in continuous conduction mode, the dual current control method can be expanded to include another area in the curve to control currents in the same polarity. By controlling the higher and lower current thresholds slope compensation is not needed and further the minimum frequency can be controlled. The tradeoff between frequency and ripple current can then be made. A low frequency would produce lower switching losses at a price of higher ripple and vice versa. Shown in FIG. 18 is how the current control method could be expanded from a boundary mode operation to a continuous mode power factor corrected converter. In this case the current thresholds are named Ilower and Iupper. Equations for preventing a lower frequency during continuous conduction mode are shown in FIGS. 19 and 20 for both polarities of line. Further in FIG. 21, the combined and simplified equations for all modes are shown. The current ripple is calculated first then the two thresholds are calculated based on the average current desired.

Thus the foregoing description provides new and useful power factor conversion methodogy and topology that is bridgeless, simple, and does not introduce common mode noise. With the foregoing description in mind, the manner in which the principles of the present invention can be implemented in various circuit topologies and methods will be apparent to those in the art.

1. A method of electronic power conversion with an inductor followed by a higher than line frequency switching half bridge combined with a diode half bridge to rectify and boost the input AC line.

2. The method of 1 with active bridges replacing the diode portion of the half bridge switched at the line frequency.

3. An electronic power control method employing rectifying circuitry and dual current thresholds to control both portions of the switching cycle for the rectifying circuitry.

4. The control method of claim 3 using thresholds of opposite polarity.

5. The control method of claim 4 with particular thresholds calculated so that both transitions will have soft commutation for the targeted average current.

6. The control method of claim 5, wherein the rectifying circuitry comprises half bridge rectifying circuitry.

7. An electronic power control method employing rectifying circuitry and a single current threshold that can be moved to either control the lower ramp threshold or upper ramp threshold for the rectifying circuitry.

8. The control method of 7 wherein the smaller of a positive ramp or negative ramp portion is used.

9. The control method of claim 8, wherein the rectifying circuitry comprises half bridge rectifying circuitry.

10. An electronic power control method employing rectifying circuitry and a single current threshold and calculating the total period required to achieve the other current threshold for the rectifying circuitry.

11. The electronic power control method of claim 10 wherein the rectifying circuitry comprises half bridge rectifying circuitry.

12. An electronic power control method employing rectifying circuitry and a single current threshold for the ramp up and calculating the ramp down time required and setting the ramp down time for the rectifying circuitry.

13. The electronic power control method of claim 11 wherein the rectifying circuitry comprises half bridge rectifying circuitry.

14. An electronic power control method employing rectifying circuitry and a single current threshold for the ramp down and calculating the ramp up time required and the setting the ramp up time of the rectifying circuitry.

15. The electronic power control method of claim 14 wherein the rectifying circuitry comprises half bridge rectifying circuitry.
